(19) United States
(12) Patent Application Publication
(10) Pub. No.: US 2006/0269715 A1
(43) Pub. Date: Nov. 30, 2006

(54) Adhesive material, method for peeling adhesive material, and pressure-sensitive adhesive tape

(75) Inventors: Munehiro Hatai, Mishima-gun (JP); Masateru Fukuoka, Mishima-gun (JP); Satoshi Hayashi, Mishima-gun (JP); Shigeru Danjo, Mishima-gun (JP); Yasuhiko Oyama, Osaka-shi (JP); Kazuhiro Shimomura, Hasuda-shi (JP); Tsuyoshi Hasegawa, Hasuda-shi (JP)

Correspondence Address: SUGHRUE MION, PLLC, 2100 PENNSYLVANIA AVENUE, N.W., SUITE 800, WASHINGTON, DC, 20037, US

(73) Assignee: SEKISUI CHEMICAL CO., LTD.

(21) Appl. No.: 11/491,280

(22) Filed: Jul. 24, 2006

Related U.S. Application Data
(62) Division of application No. 10/495,516, filed on Aug. 18, 2004.

(30) Foreign Application Priority Data
Nov. 15, 2001 (JP) 2001-350859
Dec. 4, 2001 (JP) 2001-370761

(51) Int. Cl. B32B 9/04; C08K 5/23

(52) U.S. Cl. 428/40.1; 524/190

(57) ABSTRACT

An object of the present invention is to provide an adhesive substance capable of being easily peeled off without damaging an adherend by giving stimulation thereto, a tape employing this adhesive substance, and a method for peeling off the adhesive substance. An adhesive substance, which contains a gas-generating agent for generating gas by stimulation, gas generated from said gas-generating agent being discharged to the outside of said adhesive substance so as not to foam said adhesive substance, and gas generated from said gas-generating agent peeling at least part of an adhesive surface of said adhesive substance off an adherend so as to decrease adhesive strength.

### CROSS REFERENCE TO RELATED APPLICATION

This is a Divisional application of U.S. application Ser. No. 10/495,516 filed on Aug. 18, 2004, which is a §371 of PCT Application No. PCT/JP02/05409 filed on Jun. 3, 2002, which applications are incorporated herein by reference in their entirety.

### TECHNICAL FIELD

The present invention relates to an adhesive substance capable of being easily peeled off without damaging an adherend by giving stimulation thereto, a pressure-sensitive adhesive tape employing this adhesive substance, and a method for peeling off the adhesive substance.

### BACKGROUND ART

Nowadays, adhesive substances have been widely used for a binder agent such as an adhesive, a sealing agent, a paint and a coating material, a pressure-sensitive adhesive such as a pressure-sensitive adhesive tape and a self-supporting tape, and the like.

The performances required for these adhesive substances vary with uses thereof, and some uses require that the adhesive substances exhibit adhesive property only while required, but can be easily peeled off thereafter.

For example, in the manufacturing process of IC chips, it has been proposed that a thick-film wafer is reinforced by adhering to a support plate to thereby advance the work efficiently, in the case where the thick-film wafer cut out of high-purity silicon single crystal is polished to a predetermined thickness into a thin-film wafer. Then, it is required that the adhesive substances between the thick-film wafer and the support plate stick them together firmly during the polishing process and, meanwhile, allows the obtained thin-film wafer to be peeled off the support plate without damaging after the polishing process.

A method for peeling off the adhesive substances is, for example, thought to peel off by applying physical force; however, this method has the possibility of bringing serious damage in the case where an adherend is weak.

In addition, a method for peeling off the adhesive substances by using a solvent for dissolving them is conceivable; however, this method can not be employed in the case where an adherend is deteriorated by the solvent.

Thus, there has been a problem in that a firmer adhesive strength of the adhesive substances once used for adhering makes it more difficult to peel off without damaging an adherend.

By contrast, a pressure-sensitive adhesive containing an azide compound is disclosed in Japanese Kokai Publication 2001-200234. An azide compound decomposes to discharge nitrogen gas by being irradiated with ultraviolet rays. Accordingly, when an adhesive surface stuck by using a pressure-sensitive adhesive containing an azide compound is irradiated with ultraviolet rays, nitrogen gas discharged by the decomposition of the azide compound peels part of the adhesive surface of the pressure-sensitive adhesive off an adherend so as to decrease adhesive strength, whereby the adherend can be easily peeled off.

Actually, however, nitrogen gas discharged by the decomposition of the azide compound accumulates as air bubbles, in the case where the pressure-sensitive adhesive firmly adheres to the adherend, so that there is a problem that the nitrogen gas is not sufficiently discharged to the outside of the pressure-sensitive adhesive so as to peel off the adherend.

### SUMMARY OF THE INVENTION

An object of the present invention is to provide an adhesive substance capable of being easily peeled off without damaging an adherend by giving stimulation thereto, a pressure-sensitive adhesive tape employing this adhesive substance, and a method for peeling off the adhesive substance.

The present invention provides an adhesive substance, which contains a gas-generating agent for generating gas by stimulation, gas generated from said gas-generating agent being discharged to the outside of said adhesive substance so as not to foam said adhesive substance, and gas generated from said gas-generating agent peeling at least part of an adhesive surface of said adhesive substance off an adherend so as to decrease adhesive strength. The adhesive substance of the present invention is preferably crosslinked previously, and preferably contains a component crosslinkable by stimulation. The adhesive substance of the present invention contains two kinds or more of adhesive components, and at least one of the adhesive components is preferably crosslinkable resin. The gas-generating agent preferably does not exist as particles. In addition, the gas-generating agent is preferably an azo compound and, in particular, preferably an azoamide compound represented by the following formula (1): 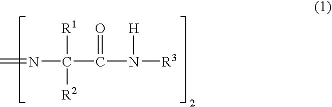
in the formula (1) , R¹ and R² each represents the same or different lower alkyl group, and R³ represents a saturated alkyl group with a carbon number of 2 or more.

With regard to the gas-generating agent of the present invention, stimulation for generating gas from the gas-generating agent preferably differs from stimulation for crosslinking the crosslinkable component. In addition, the adhesive substance of the present invention preferably contains: a gas-generating agent for generating gas by stimulation via light; and a component crosslinkable by stimulation via light, and preferably has a no-overlapped wavelength range between a wavelength range of light for generating gas from said gas-generating agent and a wavelength range of light for said crosslinkable component. In addition, the adhesive substance of the present invention containing a gas-generating agent for generating gas by stimulation via heat; and a component crosslinkable by stimulation via heat, 10-hour half-life temperature of said gas-generating agent for generating gas by stimulation via heat is preferably higher than 10-hour half-life temperature of a thermal polymerization initiator in the component crosslinkable by stimulation via heat.

The present invention encompasses a method for peeling off the adhesive substance of the present invention containing a gas-generating agent and a crosslinkable component such that stimulation for generating gas from the gas-generating agent differs from stimulation for crosslinking the crosslinkable component, the method comprising: starting to give stimulation for crosslinking the crosslinkable component to crosslink the crosslinkable component; and then, starting to giving stimulation for generating gas from the gas-generating agent to generate gas from the gas-generating agent, generated gas being discharged to the outside of the adhesive substance; and peeling at least part of the adhesive surface off the adherend so as to decrease adhesive strength.

The present invention also encompasses a method for peeling off the adhesive substance of the present invention which contains: a gas-generating agent for generating gas by stimulation via light; and a component crosslinkable by stimulation via light, and which has a no-overlapped wavelength range between a wavelength range of light for generating gas from said gas-generating agent and a wavelength range of light for said crosslinkable component, the method comprising: starting to irradiate the adhesive substance with light not having the wavelength of generating gas from the gas-generating agent but having the wavelength of crosslinking a crosslinkable component; starting to irradiate the adhesive substance with light not having the wavelength of generating gas from the gas-generating agent but having the wavelength of crosslinking a crosslinkable component; and then, starting to irradiate the adhesive substance with light having the wavelength of generating gas from the gas-generating agent to generate gas from the gas-generating agent, generated gas being discharged to the outside of the adhesive substance to peel at least part of the adhesive surface off the adherend so as to decrease adhesive strength.

The present invention also encompasses a method for peeling off the adhesive substance of the present invention which contains a gas-generating agent for generating gas by stimulation via heat; and a component crosslinkable by stimulation via heat, 10-hour half-life temperature of said gas-generating agent for generating gas by stimulation via heat being higher than 10-hour half-life temperature of a thermal polymerization initiator in said component crosslinkable by stimulation via heat, the method comprising: heating at a temperature of substantially not generating gas from the gas-generating agent but crosslinking the crosslinkable component; then, heating at a higher temperature than the above temperature to generate gas from the gas-generating agent, generated gas being discharged to the outside of the adhesive substance to peel at least part of the adhesive surface off the adherend so as to decrease adhesive strength.

With regard to a method for peeling off the adhesive substance of the present invention, stimulation of at least two kinds or more selected from the group consisting of light, heat, ultrasonic wave and impact is preferably simultaneously given on an occasion of giving stimulation for generating gas from the gas-generating agent.

The present invention also encompasses a tape comprising a layer containing the adhesive substance of the present invention formed on at least one plane of a base material.

The present invention also encompasses a tape comprising a plurality of layers containing an adhesive substance, a layer on at least one surface thereof containing the adhesive substance of the present invention, and a layer adjoining the base material not containing the adhesive substance of the present invention.

The present invention also encompasses a tape comprising a plurality of layers containing an adhesive substance, a layer on at least one surface thereof containing the adhesive substance of the present invention.

The present invention also encompasses a tape comprising a pressure-sensitive adhesive layer having adherence formed on part of a surface thereof, said pressure-sensitive adhesive layer containing the adhesive substance of the present invention.

With regard to a tape of the present invention, a non-through hole having an opening to an exterior or through-hole is preferably formed in a layer containing the adhesive substance of the present invention.

### DETAILED DISCLOSURE OF THE INVENTION

Hereinafter, the present invention will be described in detail.

An adhesive substance of the present invention contains a gas-generating agent for generating gas by stimulation. Incidentally, an adhesive substance in the present specification denotes a substance having adhesive property in a state of being applied to an adherend, and is not particularly limited as long as it is a substance exhibiting the property of adhering to at least a surface to adhere to.

Stimulation for generating gas from the above-mentioned gas-generating agent is not particularly limited, and examples thereof may include light, heat, ultrasonic wave, impact and the like.

The above-mentioned gas-generating agent for generating gas by stimulation is not particularly limited, and an azo compound, an azide compound and the like are appropriately used therefor.

Examples of the above-mentioned-azo compound may include 2,2′-azobis(N-cyclohexyl-2-methyl propionamide), 2,2′-azobis[N-(2-methyl propyl)-2-methyl propionamide], 2,2′-azobis(N-butyl-2-methyl propionamide), 2,2′-azobis[N-(2-methyl ethyl)-2-methyl propionamide], 2,2′-azobis(N-hexyl-2-methyl propionamide), 2,2′-azobis(N-propyl-2-methyl propionamide), 2,2′-azobis(N-ethyl-2-methyl propionamide), 2,2′-azobis{2-methyl-N-[1,1-bis(hydroxymethyl)-2-hydroxyethyl]propionamide}, 2,2′-azobis{2-methyl-N-[2-(1-hydroxybutyl)]propionamide}, 2,2′-azobis[2-methyl-N-(2-hydroxyethyl)propionamide], 2,2′-azobis[N-(2-propenyl)-2-methyl propionamide], 2,2′-azobis[2-(5-methyl-2-imidazoline-2-yl)propane]dihydrochloride, 2,2′-azobis[2-(2-imidazoline-2-yl)propane]dihydrochloride, 2,2′-azobis[2-(2-imidazoline-2-yl)propane]disulfate dihydrolate, 2,2′-azobis[2-(3,4,5,6-tetrahydropyrimidine-2-yl)propane]dihydrochloride, 2,2′-azobis{2-[1-(2-hydroxyethyl)-2-imidazoline-2-yl]propane}dihydrochloride, 2,2′-azobis[2-(2-imidazoline-2-yl)propane], 2,2′-azobis(2-methyl propionamidine)hydrochloride, 2,2′-azobis(2-aminopropane)dihydrochloride, 2,2′-azobis[N-(2-carboxyacyl)-2-methyl-propionamidine], 2,2′-azobis{2-[N-(2-carboxyethyl)amidine]propane}, 2,2′-azobis(2-methyl propionamide oxime), dimethyl2,2′-azobis(2-methyl propionate), dimethyl2,2′-azobisisobutyrate, 4,4′-azobis(4-cyanocarbonic acid), 4,4′-azobis(4-cyanopentanoic acid), 2,2′-azobis(2,4,4-trimethylpentane), and the like.

In particular, in view of being excellent in heat resistance and excellent in solubility into a polymer having tackiness such as the acrylic acid alkyl ester polymer which will be described later, an azoamide compound represented by the following formula (1) is preferable, such as 2,2′-azobis(N-cyclohexyl-2-methyl propionamide), 2,2′-azobis[N-(2-methyl propyl)-2-methyl propionamide], 2,2′-azobis(N-butyl-2-methyl propionamide), 2,2′-azobis[N-(2-methyl ethyl)-2-methyl propionamide], 2,2′-azobis(N-hexyl-2-methyl propionamide), 2,2′-azobis(N-propyl-2-methyl propionamide) and 2,2′-azobis(N-ethyl-2-methyl propionamide).

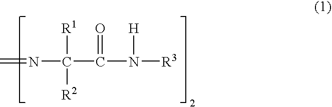

In the formula (1), R¹ and R² each represents lower alkyl group, and R³ represents a saturated alkyl group with a carbon number of 2 or more. Herein, R¹ and R² may be same as or different from each other.

These azo compounds generate nitrogen gas by stimulation via light, heat and the like.

Examples of the above-mentioned azide compound may include 3-azide methyl-3-methyl oxetane, terephthalazide, para-tert-butylbenzazide; a polymer having an azide group such as a glycidyl azide polymer obtained by the ring-opening polymerization of 3-azide methyl-3-methyl oxetane, and the like. These azide compounds decompose to generate nitrogen gas by giving stimulation via light of a specific wavelength, heat, ultrasonic wave, impact and the like.

Among these gas-generating agents, the above-mentioned azide compound easily decomposes to discharge nitrogen gas also by giving impact; therefore, it has a problem in that the handling thereof is difficult. In addition, the above-mentioned azide compound once starts to decompose and causes a chain reaction to explosively discharge nitrogen gas beyond control, whereby it has a problem in that an adherend is occasionally damaged by the nitrogen gas explosively discharged. The quantity used of the above-mentioned azide compound is limited in view of such problems, and the limited quantity used occasionally brings an insufficient effect.

Meanwhile, the above-mentioned azo compound, unlike the azide compound, does not generate gas by impact; therefore, the handling thereof is extremely easy. In addition, the above-mentioned azo compound does not cause a chain reaction to explosively generate gas and thereby does not damage an adherend, and the interruption of irradiation of light discontinues the generation of gas, whereby it is the advantage to be capable of controlling adhesive property for uses. Consequently, the azo compound is more preferably used as the above-mentioned gas-generating agent.

The above-mentioned gas-generating agent preferably does not exist as particles. Incidentally, in the present specification, the nonexistence of the gas-generating agent as particles signifies that the gas-generating agent can not be confirmed when the adhesive substance of the present invention is observed by an electron microscope. When the gas-generating agent exists as particles in the adhesive substance of the present invention, light is scattered at an interface of the particles in irradiating with light as stimulation for generating gas so as to decrease gas-generating efficiency and surface smoothness is deteriorated in making the adhesive substance of the present invention into a state of a coating film.

In order that the above-mentioned gas-generating agent does not exist as particles, a gas-generating agent to be dissolved in the adhesive substance of the present invention is typically selected; meanwhile, in the case of selecting a gas-generating agent not to be dissolved in the adhesive substance of the present invention, the gas-generating agent is minutely dispersed into the adhesive substance of the present invention, for example, by using a disperser and a dispersant together therewith.

In addition, the gas-generating agent is preferably minute particles. Further, these minute particles are preferably made into finer minute particles as required, for example, by using a disperser, a kneading device and the like. That is to say, when the adhesive substance of the present invention is observed by an electron microscope, the gas-generating agent is more preferably dispersed to a state of being incapable of confirmation.

With regard to the adhesive substance of the present invention, gas generated from the above-mentioned gas-generating agent is discharged to the outside of the adhesive substance. Thus, when an adhesive surface stuck by using the adhesive substance of the present invention is irradiated with light, the gas generated from the gas-generating agent peels at least part of the adhesive surface of the adhesive substance off an adherend so as to decrease adhesive strength, whereby the adherend can be easily peeled off. On this occasion, most of the gas generated from the gas-generating agent is preferably discharged to the outside of the adhesive substance. When most of gas generated from the above-mentioned gas-generating agent is not discharged to the outside of the adhesive substance, the gas generated from the gas-generating agent foams the adhesive substance on the whole so as not to obtain the sufficient effect of decreasing adhesive strength and cause adhesive deposit in an adherend. Unless adhesive deposit is caused in an adherend, part of the gas generated from the gas-generating agent may be dissolved into the adhesive substance or exist as air bubbles in the adhesive substance.

The adhesive substance of the present invention is preferably crosslinked previously in order to adjust elastic modulus in a state before generating gas by stimulation to decrease adhesive strength. For example, the adhesive substance may be crosslinked to the degree of retaining adhesive property by previously giving stimulation via light or heat to photo-curing adhesive resin or thermosetting adhesive resin which will be described later, and a chemically crosslinked isocyanate compound and the like may be compounded therewith. The previous crosslinking increases elastic modulus of the adhesive substance of the present invention, whereby gas generated from the gas-generating agent stays as air bubbles in the adhesive substance with difficulty so as to promote the discharge to the outside of the adhesive substance.

The adhesive substance of the present invention preferably contains a component crosslinkable by stimulation. Examples of the above-mentioned crosslinkable component by stimulation may include photo-curing adhesive resin mainly containing an acrylic acid alkyl ester and/or methacrylic acid alkyl ester polymerizable polymer having a radical polymerizable unsaturated bond in a molecule and a radical polymerizable polyfunctional oligomer or monomer and containing a photopolymerization initiator as required, and thermosetting adhesive resin mainly containing an acrylic acid alkyl ester and/or methacrylic acid alkyl ester polymerizable polymer having a radical polymerizable unsaturated bond in a molecule and a radical polymerizable polyfunctional oligomer or monomer and containing a thermal polymerization initiator.

The above-mentioned polymerizable polymer can be obtained, for example, by previously synthesizing a (meth)acrylic polymer having a functional group in a molecule (hereinafter, referred to as a functional group-containing (meth)acrylic polymer) so as to be reacted with a compound having a functional group for reacting with the above-mentioned functional group and a radical polymerizable unsaturated bond in a molecule (hereinafter, referred to as a functional group-containing unsaturated compound).

The above-mentioned functional group-containing (meth)acrylic polymer, similar to the case of a general (meth)acrylic polymer as a polymer having tackiness at normal temperature, is obtained by conventionally copolymerizing an acrylic acid alkyl ester and/or methacrylic acid alkyl ester as a main monomer, in which a carbon number of an alkyl group is typically in a range of 2 to 18, and a functional group-containing monomer and additionally, as required, another monomer for modifying copolymerizable therewith. The weight-average molecular weight of the above-mentioned functional group-containing (meth)acrylic polymer is typically 200,000 to 2,000,000.

Examples of the above-mentioned functional group-containing monomer may include a carboxyl group-containing monomer such as acrylic acid and methacrylic acid; a hydroxyl group-containing monomer such as hydroxyethyl acrylate and hydroxyethyl methacrylate; an epoxy group-containing monomer such as glycidyl acrylate and glycidyl methacrylate; an isocyanate group-containing monomer such as isocyanateethyl acrylate and isocyanateethyl methacrylate; an amino group-containing monomer such as aminoethyl acrylate and aminoethyl methacrylate; and the like.

Examples of the above-mentioned another copolymerizable monomer for modifying may include various monomers used for a general (meth)acrylic polymer, such as vinyl acetate, acrylonitrile and styrene.

As the above-mentioned functional group-containing unsaturated compound usable for being reacted with the functional group-containing (meth)acrylic polymer, a compound similar to the above-mentioned functional group-containing monomer in accordance with a functional group of the above-mentioned functional group-containing (meth)acrylic polymer can be used. For example, in the case where a functional group of the above-mentioned functional group-containing (meth)acrylic polymer is a carboxyl group, an epoxy group-containing monomer and an isocyanate group-containing monomer are used; in the case where the functional group is a hydroxyl group, an isocyanate group-containing monomer is used; in the case where the functional group is an epoxy group, a carboxyl group-containing monomer and an amide group-containing monomer such as acrylamide are used; and in the case where the functional group is an amino group, an epoxy group-containing monomer is used.

The above-mentioned polyfunctional oligomer or monomer is preferably an oligomer or monomer having a molecular weight of 10,000 or less, and more preferably having a molecular weight of 5,000 or less and a radical pclymerizable unsaturated bond number of 2 to 20 in a molecule so that the three-dimensional net working of a pressure-sensitive adhesive layer is efficiently performed by the irradiation of light. Examples of the more preferable polyfunctional oligomer or monomer may include trimethylolpropane tri(meth)acrylate, tetramethylolmethane tetra(meth)acrylate, pentaerythritol tri(meth)acrylate, pentaerythritol tetra(meth)acrylate, dipentaerythritol monohydroxypenta(meth)acrylate, dipentaerythritol hexa(meth)acrylate, and the like. Additionally, examples thereof may include 1,4-butylene glycol di(meth)acrylate, 1,6-hexanediol di(meth)acrylate, polyethylene glycol di(meth)acrylate, commercially available oligoester (meth)acrylate, and the like. These polyfunctional oligomers or monomers may be used singly or together in two kinds or more.

An example of the above-mentioned photopolymerization initiator may include an initiator activated by being irradiated with light having a wavelength of 250 to 800 nm, and examples of such a photopolymerization initiator may include an acetophenone derivative compound such as methoxyacetophenone; a benzoin ether compound such as benzoin propyl ether and benzoin isobutyl ether; a ketal derivative compound such as benzyl dimethylketal and acetophenone diethylketal; a phosphine oxide derivative compound; a photo-radical polymerization initiator such as a bis(η5-cyclopentadienyl)titanocene derivative compound, benzophenone, Michler's ketone, chlorothioxanthone, dodecylthioxanthone, dimethylthioxanthone, diethylthioxanthone, α-hydroxycyclohexyl phenyl ketone and 2-hydroxymethylphenylpropane. These photopolymerization initiators may be used singly or together in two kinds or more.

An example of the above-mentioned thermal polymerization initiator may include an initiator which decomposes by heat to generate active radical for initiating polymerization and cure, and specific examples thereof may include dicumyl peroxide, di-tert-butyl peroxide, tert-butyl peroxybenzoale, tert-butyl hydroperoxide, benzoyl peroxide, cumene hydroperoxide, diisopropyl benzene hydroperoxide, para-menthane hydroperoxide, di-tert-butyl peroxide, and the like. In particular, cumene hydroperoxide, para-menthane hydroperoxide, di-tert-butyl peroxide and the like are preferable in view of a high pyrolysis temperature. A commercially available thermal polymerization initiator among these is not particularly limited, as which Perbutyl D, Perbutyl H, Perbutyl P, Permenta H (all of which are made by NOF CORPORATION) and the like are preferable. These thermal polymerization initiators may be used singly or together in two kinds or more.

With regard to post-curing adhesive resin such as the above-mentioned photo-curing adhesive resin or thermosetting adhesive resin, the total adhesive resin is uniformly and promptly polymerized and crosslinked for integration by stimulation via light or heat, whereby tan δ in a rubbery range is remarkably decreased by polymerization and cure to considerably deteriorate tack strength. Further, when stimulation via light or heat is given to the adhesive substance of the present invention containing the above-mentioned post-curing adhesive resin, tan δ in a rubbery range is decreased so as to cure the total adhesive substance, whereby gas generated from the gas-generating agent stays as air bubbles in the adhesive substance with difficulty so as to promote the discharge to the outside of the adhesive substance.

The above-mentioned effect can not be obtained unless crosslinking is advanced before gas is generated from the gas-generating agent. Therefore, the above-mentioned crosslinkable component to be selected is preferably a crosslinkable component such that crosslinking is formed before gas is generated from the gas-generating agent. Accordingly, stimulation for generating gas from the gas-generating agent and stimulation for crosslinking the crosslinkable component are preferably different from or same as each other, even in which case crosslinking can be formed before by the presence of a no-overlapping range.

For example, in the case where stimulation for generating gas from a gas-generating agent differs from stimulation for crosslinking a crosslinkable component, stimulation for generating gas from the gas-generating agent is given after stimulation for crosslinking the crosslinkable, component is given, whereby more effectively generated gas can be discharged to the outside of an adhesive substance.

In addition, for example, in the case where a gas-generating agent for generating gas by stimulation via light is used as a gas-generating agent, and a component crosslinkable by light such as the above-mentioned photo-curing adhesive resin is used as a component crosslinkable by stimulation, a wavelength range preferably exists such that a wavelength of light for generating gas from the above-mentioned gas-generating agent does not overlap with a wavelength of light for crosslinking the above-mentioned crosslinkable component. Thus, an adhesive substance is irradiated with light of a wavelength for generating gas from the gas-generating agent after being irradiated with light of a wavelength for crosslinking the crosslinkable component, whereby more effectively generated gas can be discharged to the outside of the adhesive substance.

In addition, for example, in the case where a gas-generating agent for generating gas by stimulation via heat is used as a gas-generating agent, and a component crosslinkable by heat such as the above-mentioned thermosetting adhesive resin is used as a component crosslinkable by stimulation, 10-hour half-life temperature of the above-mentioned gas-generating agent for generating gas by stimulation via heat is preferably higher than 10-hour half-life temperature of a thermal polymerization initiator in the above-mentioned crosslinkable component by stimulation via heat. 10-hour half-life temperature of the above-mentioned gas-generating agent for generating gas by stimulation via heat is more preferably higher by 20° C. or more than 10-hour half-life temperature of a thermal polymerization initiator in the above-mentioned crosslinkable component by stimulation via heat. Thus, heat of a temperature for crosslinking the crosslinkable component is applied and, then, heat of a temperature for generating gas from the gas-generating agent is applied, whereby more effectively generated gas can be discharged to the outside of an adhesive substance.

The adhesive substance of the present invention preferably contains two kinds or more of adhesive components, and at least one of the above-mentioned adhesive components is preferably the above-mentioned crosslinking resin.

A resin component of the adhesive substance of the present invention is not particularly limited, and thermoplastic resin is preferably selected for use from among the above-mentioned resins. In the case of using thermoplastic resin as a resin component, an adhesive substance can adhere to an adherend in a state of being softened by heat, and thereby adheres closely even to an adherend having irregularities on a surface thereof so as to obtain a powerful adhesive strength.

In the case where a gas-generating agent for generating gas by stimulation via light, such as an azide compound or an azo compound, is used as the above-mentioned gas-generating agent, preferably, the adhesive substance of the present invention further contains a photosensitizer. The above-mentioned photosensitizer has the effect of amplifying stimulation via light to the above-mentioned gas-generating agent, so that less irradiation of light allows gas to be discharged. In addition, light in a wider wavelength range allows gas to be discharged; therefore, even if an adherend does not transmit light of a wavelength for generating gas from an azide compound or an azo compound such as polyimide, the irradiation of light via the adherend allows gas to be generated, leading to a wider selection of the adherend.

The above-mentioned photosensitizer is not particularly limited and, for example, a thioxanthone sensitizer is preferable. In addition, a thioxanthone sensitizer can be used as a photopolymerization initiator.

An example of method for producing the adhesive substance of the present invention may include a method for kneading a resin component and the above-mentioned gas-generating agent. However, in the case where the gas-generating agent is an azide compound which easily decomposes to discharge nitrogen gas also by giving heat and impact, and once starts to decompose and cause a chain reaction so as to explosively discharge nitrogen gas beyond control, the gas-generating agent has the possibility of starting to decompose by heat and impact in kneading, whereby it is difficult to produce an adhesive substance containing a large quantity of the gas-generating agent.

In such a case, it is preferable to employ a method for producing an adhesive substance such that an adhesive substance material containing the gas-generating agent, a polymerizable material and a photopolymerization initiator is irradiated with ultraviolet rays or visible light of a longer wavelength than the photosensitive wavelength of an azide compound so as to polymerize the above-mentioned polymerizable material by activating the above-mentioned photopolymerization initiator. This method does not require the kneading of the resin component and the gas-generating agent, which does not have the possibility of starting to decompose by heat and impact. In addition, the production of an adhesive substance can be completed by one-time reaction without requiring the use of a solvent, whereby an adhesive substance containing a large quantity of the gas-generating agent can be produced safely and easily.

In the above-mentioned production method, the polymerizable material is used such as to mainly contain an acrylic monomer or an acrylic oligomer and, additionally, the photopolymerization initiator is used such as to be activated by being irradiated with ultraviolet rays or visible light of a longer wavelength than the photosensitive wavelength of the gas-generating agent. Examples of such a photopolymerization initiator may include an acetophenone derivative compound such as methoxyacetophenone; a benzoin ether compound such as benzoin propyl ether and benzoin isobutyl ether; a ketal derivative compound such as benzyl dimethylketal and acetophenone diethylketal; a phosphine oxide derivative compound; a photo-radical polymerization initiator such as a bis(η5-cyclopentadienyl)titanocene derivative compound, benzophenone, Michler's ketone, chlorothioxanthone, dodecylthioxanthone, dimethylthioxanthone, diethylthioxanthone, α-hydroxycyclohexyl phenyl ketone and 2-hydroxymethylphenylpropane. These photopolymerization initiators may be used singly or together in two kinds or more.

In order to peel off the adhesive substance of the present invention containing a gas-generating agent and a crosslinkable component such that stimulation for generating gas from the gas-generating agent differs from stimulation for crosslinking the crosslinkable component, stimulation for crosslinking the crosslinkable component is given first. Before or after the stimulation for crosslinking the crosslinkable component finishes being given, stimulation for generating gas from the gas-generating agent is given, whereby more effectively generated gas can be discharged to the outside of the adhesive substance.

That is to say, the present invention encompasses a method for peeling off the adhesive substance of the present invention containing a gas-generating agent and a crosslinkable component such that stimulation for generating gas from the gas-generating agent differs from stimulation for crosslinking the crosslinkable component, the method comprising: starting to give stimulation for crosslinking the crosslinkable component; and then, starting to giving stimulation for generating gas from the gas-generating agent to generate gas from the gas-generating agent, generated gas being discharged to the outside of the adhesive substance to peel at least part of the adhesive surface off the adherend so as to decrease adhesive strength.

In order to peel off the adhesive substance of the present invention containing a gas-generating agent for generating gas by stimulation via light and a component crosslinkable by stimulation via light, the adhesive substance is first irradiated with light of a wavelength for crosslinking the crosslinkable component in the case where a wavelength range exists such that a wavelength of light for generating gas from the above-mentioned gas-generating agent does not overlap with a wavelength of light for crosslinking the above-mentioned crosslinkable component. Before or after finishing being irradiated with the light of a wavelength, the adhesive substance is irradiated with light of a wavelength for generating gas from the gas-generating agent, whereby more effectively generated gas can be discharged to the outside of the adhesive substance.

That is to say, the present invention also encompasses a method for peeling off the adhesive substance of the present invention which contains: a gas-generating agent for generating gas by stimulation via light; and a component crosslinkable by stimulation via light, and which has a no-overlapped wavelength range between a wavelength range of light for generating gas from said gas-generating agent and a wavelength range of light for said crosslinkable component, the method comprising: irradiating the adhesive substance with light not having a wavelength of generating gas from the gas-generating agent but having a wavelength of crosslinking the crosslinkable component; starting to irradiate the adhesive substance with light not having the wavelength of generating gas from the gas-generating agent but having the wavelength of crosslinking a crosslinkable component; and then, starting to irradiate the adhesive substance with light having the wavelength of generating gas from the gas-generating agent to generate gas from the gas-generating agent, generated gas being discharged to the outside of the adhesive substance to peel at least part of the adhesive surface off the adherend so as to decrease adhesive strength.

In order to peel off the adhesive substance of the present invention containing a gas-generating agent for generating gas by stimulation via heat and a component crosslinkable by stimulation via heat, wherein 10-hour half-life temperature of the above-mentioned gas-generating agent for generating gas by stimulation via heat is higher than 10-hour half-life temperature of a thermal polymerization initiator in the above-mentioned crosslinkable component by stimulation via heat, heat of a temperature for crosslinking the crosslinkable component is applied first. The above-mentioned temperature for crosslinking the crosslinkable component is preferably higher by 10° C. or more than 10-hour half-life temperature of a thermal polymerization initiator in the crosslinkable component, and is more preferably higher by 20° C. or more than 10-hour half-life temperature of a thermal polymerization initiator in the crosslinkable component. Before or after the heat finishes being applied, heat of a temperature for generating gas from the gas-generating agent is applied, whereby more effectively generated gas can be discharged to the outside of the adhesive substance.

That is to say, the present invention also encompasses a method for peeling off the adhesive substance of the present invention containing a gas-generating agent for generating gas by stimulation via heat; and a component crosslinkable by stimulation via heat, wherein 10-hour half-life temperature of said gas-generating agent for generating gas by stimulation via heat being higher than 10-hour half-life temperature of a thermal polymerization initiator in said component crosslinkable by stimulation via heat, the method comprising: heating at a temperature of substantially not generating gas from the gas-generating agent but crosslinking the crosslinkable component; then, heating at a higher temperature than the above temperature to generate gas from the gas-generating agent, generated gas being discharged to the outside of the adhesive substance to peel at least part of the adhesive surface off the adherend so as to decrease adhesive strength.

With regard to a method for peeling off the adhesive substance of the present invention, stimulation of at least two kinds or more selected from the group consisting of light, heat, ultrasonic wave and impact is preferably given simultaneously on the occasion of giving stimulation for generating gas from a gas-generating agent. Thus, gas can be generated more efficiently from a gas-generating agent.

The adhesive substance of the present invention can be used for various adhesive products. Examples of the above-mentioned adhesive products may include an adhesive, a pressure-sensitive adhesive, a paint, a coating material, a sealing agent and the like, in which the adhesive substance of the present invention is used as binder resin. Such adhesive products can be manufactured by using the adhesive substance of the present invention as binder resin and adding various publicly known addition agents in accordance with the purpose of each of the adhesive products.

The above-mentioned addition agents are not particularly limited, and examples thereof may include a tackifier, a filler, a weatherability imparting agent, a viscosity modifier, a dyeing agent and the like.

The adhesive substance of the present invention is also preferable as a pressure-sensitive adhesive of a pressure-sensitive adhesive tape such as a pressure sensitive adhesive single coated tape, a pressure sensitive adhesive double coated tape and a nonsupport tape (a self-supporting tape). An adhesive substance in which thermoplastic resin is used as a resin component can adhere to an adherend in a state of being softened by heat, and thereby adheres closely even to an adherend having irregularities on a surface thereof so as to obtain a powerful adhesive strength more preferably.

Examples of a pressure-sensitive adhesive tape in which the adhesive substance of the present invention is used as a pressure-sensitive adhesive may include a packaging tape, a decorative tape, a surface protection tape, a masking tape, a dicing tape, a back grind tape and the like.

The present invention also encompasses a tape comprising a layer containing the adhesive substance of the present invention formed on at least one plane of a base material.

Examples of the tape of the present invention may include a pressure sensitive adhesive single coated tape comprising a layer containing the adhesive substance of the present invention formed on only one plane of a base material, a pressure sensitive adhesive double coated tape comprising a layer containing the adhesive substance of the present invention formed on both planes of a base material, a pressure sensitive adhesive double coated tape such that only a pressure-sensitive adhesive layer on one plane thereof is a layer containing the adhesive substance of the present invention, and the like.

The tape of the present invention preferably comprises a plurality of layers formed on at least one plane of a base material. In this case, it is more preferable that an outermost layer is a layer containing the adhesive substance of the present invention and a layer adjoining the base material is a layer not containing the adhesive substance of the present invention. Thus, gas generated from the above-mentioned gas-generating agent is discharged only to an adhesive surface to an adherend and is not discharged to the side of the base material of the tape; therefore, the adherend can be peeled off without causing adhesive deposit on the side of the adherend.

In addition, in the case where a layer containing the adhesive substance of the present invention adjoins a layer not containing the adhesive substance of the present invention, the layer not containing the adhesive substance of the present invention preferably comprises a resin component of a different composition from a resin component composing the layer containing the adhesive substance of the present invention. Thus, the gas-generating agent in the layer containing the adhesive substance of the present invention can be prevented from shifting to another layer not containing the adhesive substance of the present invention.

The present invention also encompasses a tape comprising a plurality of layers containing an adhesive substance, wherein a layer on at least one surface thereof contains the adhesive substance of the present invention. Such a tape not having a base material is also called a self-supporting tape. A gas-generating agent exists only on a surface part of the plurality of layers containing an adhesive substance, and thereby air bubbles is not caused in a central part of a self-supporting tape so as to prevent the decrease of cohesive force, which tape can be peeled off an adherend without causing adhesive deposit. In addition, in the case where a layer on only one surface thereof contains the adhesive substance of the present invention, only an adherend on the surface can be peeled off.

The present invention also encompasses a tape comprising a pressure-sensitive adhesive layer having adherence formed on part of a surface thereof, wherein the above-mentioned pressure-sensitive adhesive layer contains the adhesive substance of the present invention. With the use of such a pressure-sensitive adhesive tape in which a pressure-sensitive adhesive layer having adhesive property is partially formed, a surface not having tackiness touches a particularly fragile part of an adherend, which part is easily damaged in peeling off, and the tape adheres only to another comparatively stout part, whereby the tape can be peeled off without damaging the adherend. In addition, the formation of the pressure-sensitive adhesive layer in an optional pattern allows adhesive strength of the tape to be freely adjusted.

A non-through hole having an opening to the exterior or a through-hole is preferably formed in a layer containing the adhesive substance of the present invention, which is formed in these tapes. Such a non-through hole or a through-hole allows gas generated from a gas-generating agent to be more easily discharged to the outside of the adhesive substance. The discharge of gas is promoted-only to a plane on the side of an opening, in the case where the above-mentioned non-through hole is formed, while the discharge of gas is promoted to planes on both sides, in the case where the above-mentioned through-hole is formed.

### BEST MODE FOR CARRYING OUT THE INVENTION

The present invention will be further described hereinafter referring to examples; however, the present invention is not limited thereto.

### EXAMPLE 1

<Preparation of Adhesive Substance>

The following compounds were dissolved in ethyl acetate so as to be irradiated with ultraviolet rays for polymerization and obtain an acrylic copolymer having a weight-average molecular weight of 700,000.

3.5 parts by weight of 2-isocyanatoethyl acrylate was added to 100 parts by weight of resin solids content of the ethyl acetate solution containing the obtained acrylic copolymer so as to be reacted, and further 20 parts by weight of pentaerythritol triacrylate, 0.5 part by weight of benzophenone and 0.3 part by weight of polyisocyanate were mixed with 100 parts by weight of resin solids content of the reacted ethyl acetate solution to prepare the ethyl acetate solution of a pressure-sensitive adhesive (1).

| | | |
|---|---|---|
| butyl acrylate | 79 | parts by weight |
| ethyl acrylate | 15 | parts by weight |
| acrylic acid | 1 | part by weight |
| 2-hydroxyethyl acrylate | 5 | parts by weight |
| photopolymerization initiator (IRGACURE 651, | 0.2 | part by weight |
| 50%-ethyl acetate solution) | | |
| lauryl mercaptan | 0.01 | part by weight |

100 parts by weight of 3-azide methyl-3-methyl oxetane was mixed with 100 parts by weight of resin solids content of the ethyl acetate solution of a pressure-sensitive adhesive (1) to prepare the ethyl acetate solution of a pressure-sensitive adhesive (2) containing an azide compound.

<Manufacture of Pressure-Sensitive Adhesive Tape>

The surface with corona treatment of a transparent polyethylene terephthalate (PET) film having a thickness of 38 μm with corona treatment on one side was coated with the ethyl acetate solution of a pressure-sensitive adhesive (1) by a doctor knife so as to have a dry film thickness of approximately 10 μm and dry the coating solution by volatilizing the solvent. The pressure-sensitive adhesive layer after being dried exhibited tackiness in a dry state.

Meanwhile, a PET film having a thickness of 38 μm with release treatment on surfaces was coated with the ethyl acetate solution of a pressure-sensitive adhesive (2) by a bar coater so as to have a thickness of 5 μm after being dried and dry the pressure-sensitive adhesive layer by volatilizing the solvent.

The pressure-sensitive adhesive (1) layer formed on the PET film with corona treatment on one side and the pressure-sensitive adhesive (2) layer formed on the PET film with release treatment were bonded together and thereafter cured at a temperature of 40° C. for 3 days to obtain a pressure-sensitive adhesive tape 1.

<Sticking and Peeling of Pressure-Sensitive Adhesive Tape>

The obtained pressure-sensitive adhesive tape 1 was stuck to a quartz glass plate.

The obtained pressure-sensitive adhesive tape 1 was irradiated with ultraviolet rays from the side of this quartz glass plate to thereafter observe many parts, in which the pressure-sensitive adhesive was peeled off the glass, on an adhesive interface via the glass. The pressure-sensitive adhesive tape was capable of being easily peeled off the glass plate.

### EXAMPLE 2

<Preparation of Adhesive Substance>

100 parts by weight of 2,2′-azobis-(N-butyl-2-methyl propionamide) was mixed with 100 parts by weight of resin solids content of the ethyl acetate solution of a pressure-sensitive adhesive (1) manufactured in Example 1 to prepare the ethyl acetate solution of a pressure-sensitive adhesive (3) containing an azo compound.

<Manufacture of Pressure-Sensitive Adhesive Tape>

The surface with corona treatment of a transparent polyethylene terephthalate (PET) film having a thickness of 38 μm with corona treatment on one side was coated with the ethyl acetate solution of a pressure-sensitive adhesive (1) by a doctor knife so as to have a dry film thickness of approximately 10 μm and dry the coating solution by volatilizing the solvent. The pressure-sensitive adhesive layer after being dried exhibited tackiness in a dry state.

Meanwhile, a PET film having a thickness of 38 μm with release treatment on surfaces was coated with the ethyl acetate solution of a pressure-sensitive adhesive (3) by a bar coater so as to have a thickness of 5 μm after being dried and dry the pressure-sensitive adhesive layer by volatilizing the solvent.

The pressure-sensitive adhesive (1) layer formed on the PET film with corona treatment on one side and the pressure-sensitive adhesive (3) layer formed on the PET film with release treatment were bonded together and thereafter cured at a temperature of 40° C. for 3 days to obtain a pressure-sensitive adhesive tape 2.

<Sticking and Peeling of Pressure-Sensitive Adhesive Tape>

The obtained pressure-sensitive adhesive tape 2 was stuck to a quartz glass plate.

The obtained pressure-sensitive adhesive tape 1 was irradiated with ultraviolet rays from the side of this quartz glass plate to thereafter observe many parts, in which the pressure-sensitive adhesive was peeled off the glass, on an adhesive interface via the glass. The pressure-sensitive adhesive tape was capable of being easily peeled off the glass plate.

### EXAMPLE 3

<Preparation of Adhesive Substance>

The following compounds were dissolved in ethyl acetate so as to be irradiated with ultraviolet rays for polymerization and obtain an acrylic copolymer having a weight-average molecular weight of 700,000.

3.5 parts by weight of 2-isocyanatoethyl acrylate was added to 100 parts by weight of resin solids content of the ethyl acetate solution containing the obtained acrylic copolymer so as to be reacted, and further 20 parts by weight of pentaerythritol triacrylate, 0.5 part by weight of a photopolymerization initiator (IRGACURE 819) and 0.3 part by weight of polyisocyanate were mixed with 100 parts by weight of resin solids content of the reacted ethyl acetate solution to prepare the ethyl acetate solution of a pressure-sensitive adhesive (4).

| | | |
|---|---|---|
| butyl acrylate | 79 | parts by weight |
| ethyl acrylate | 15 | parts by weight |
| acrylic acid | 1 | part by weight |
| 2-hydroxyethyl acrylate | 5 | parts by weight |
| photopolymerization initiator (IRGACURE 651, | 0.2 | part by weight |
| 50%-ethyl acetate solution) | | |
| lauryl mercaptan | 0.01 | part by weight |

100 parts by weight of 3-azide methyl-3-methyl oxetane was mixed with 100 parts by weight of resin solids content of the ethyl acetate solution of a pressure-sensitive adhesive (4) to prepare the ethyl acetate solution of a pressure-sensitive adhesive (5) containing an azide compound.

<Manufacture of Pressure-Sensitive Adhesive Tape>

The surface with corona treatment of a transparent polyethylene terephthalate (PET) film having a thickness of 38 μm with corona treatment on one side was coated with the ethyl acetate solution of a pressure-sensitive adhesive (4) by a doctor knife so as to have a dry film thickness of approximately 10 μm and dry the coating solution by volatilizing the solvent. The pressure-sensitive adhesive layer after being dried exhibited tackiness in a dry state.

Meanwhile, a PET film having a thickness of 38 μm with release treatment on surfaces was coated with the ethyl acetate solution of a pressure-sensitive adhesive (5) by a bar coater so as to have a thickness of 5 μm after being dried and dry the pressure-sensitive adhesive layer by volatilizing the solvent.

The pressure-sensitive adhesive (4) layer formed on the PET film with corona treatment on one side and the pressure-sensitive adhesive (5) layer formed on the PET film with release treatment were bonded together and thereafter cured at a temperature of 40° C. for 3 days to obtain a pressure-sensitive adhesive tape 3.

<Sticking and Peeling of Pressure-Sensitive Adhesive Tape>

The obtained pressure-sensitive adhesive tape 3 was stuck to a quartz glass plate.

The pressure-sensitive adhesive (4) layer and the pressure-sensitive adhesive (5) layer were irradiated with ultraviolet rays having a wavelength of 400 nm for polymerization and cure from the side of this quartz glass plate by using a metal halogen lamp with short-wavelength light cut out via a filter. Subsequently, the pressure-sensitive adhesive (4) layer and the pressure-sensitive adhesive (5) layer were irradiated with ultraviolet rays having a wavelength of 313 nm to thereafter observe many parts, in which the pressure-sensitive adhesive was peeled off the glass, on an adhesive interface via the glass. The pressure-sensitive adhesive tape was capable of being easily peeled off the glass plate.

### EXAMPLE 4

<Preparation of Adhesive Substance>

100 parts by weight of 2,2′-azobis-(N-butyl-2-methyl propionamide) was mixed with 100 parts by weight of resin solids content of the ethyl acetate solution of a pressure-sensitive adhesive (4) manufactured in Example 3 to prepare the ethyl acetate solution of a pressure-sensitive adhesive (6) containing an azo compound.

<Manufacture of Pressure-Sensitive Adhesive Tape>

The surface with corona treatment of a transparent polyethylene terephthalate (PET) film having a thickness of 38 μm with corona treatment on one side was coated with the ethyl acetate solution of a pressure-sensitive adhesive (4) by a doctor knife so as to have a dry film thickness of approximately 10 μm and dry the coating solution by volatilizing the solvent. The pressure-sensitive adhesive layer after being dried exhibited tackiness in a dry state.

Meanwhile, a PET film having a thickness of 38 μm with release treatment on surfaces was coated with the ethyl acetate solution of a pressure-sensitive adhesive (6) by a bar coater so as to have a thickness of 5 μm after being dried and dry the pressure-sensitive adhesive layer by volatilizing the solvent.

The pressure-sensitive adhesive (4) layer formed on the PET film with corona treatment on one side and the pressure-sensitive adhesive (6) layer formed on the PET film with release treatment were bonded together and thereafter cured at a temperature of 40° C. for 3 days to obtain a pressure-sensitive adhesive tape 4.

<Sticking and Peeling of Pressure-Sensitive Adhesive Tape>

The obtained pressure-sensitive adhesive tape 4 was stuck to a quartz glass plate.

The pressure-sensitive adhesive (4) layer and the pressure-sensitive adhesive (6) layer were irradiated with ultraviolet rays having a wavelength of 400 nm for polymerization and cure from the side of this quartz glass plate by using a metal halogen lamp with short-wavelength light cut out via a filter. Subsequently, the pressure-sensitive adhesive (4) layer and the pressure-sensitive adhesive (6) layer were irradiated with ultraviolet rays having a wavelength of 365 nm to thereafter observe many parts, in which the pressure-sensitive adhesive was peeled off the glass, on an adhesive interface via the glass. The pressure-sensitive adhesive tape was capable of being easily peeled off the glass plate.

### EXAMPLE 5

<Preparation of Adhesive Substance>

The following compounds were dissolved in ethyl acetate so as to be irradiated with ultraviolet rays for polymerization and obtain an acrylic copolymer having a weight-average molecular weight of 700,000.

3.5 parts by weight of 2-isocyanatoethyl acrylate was added to 100 parts by weight of resin solids content of the ethyl acetate solution containing the obtained acrylic copolymer so as to be reacted, and further 20 parts by weight of pentaerythritol triacrylate, 0.5 part by weight of Perbutyl D (made by NOF corporation) and 0.3 part by weight of polyisocyanate were mixed with 100 parts by weight of resin solids content of the reacted ethyl acetate solution to prepare the ethyl acetate solution of a pressure-sensitive adhesive (7).

| | | |
|---|---|---|
| butyl acrylate | 79 | parts by weight |
| ethyl acrylate | 15 | parts by weight |
| acrylic acid | 1 | part by weight |
| 2-hydroxyethyl acrylate | 5 | parts by weight |
| photopolymerization initiator (IRGACURE 651, | 0.2 | part by weight |
| 50%-ethyl acetate solution) | | |
| lauryl mercaptan | 0.01 | part by weight |

100 parts by weight of glycidyl azide polymer was mixed with 100 parts by weight of resin solids content of the ethyl acetate solution of a pressure-sensitive adhesive (7) to prepare the ethyl acetate solution of a pressure-sensitive adhesive (8) containing an azide compound.

<Manufacture of Pressure-Sensitive Adhesive Tape>

The surface with corona treatment of a transparent PET film having a thickness of 38 μm with corona treatment on one side was coated with the ethyl acetate solution of a pressure-sensitive adhesive (7) by a doctor knife so as to have a dry film thickness of approximately 10 μm and dry the coating solution by volatilizing the solvent. The pressure-sensitive adhesive layer after being dried exhibited tackiness in a dry state.

Meanwhile, a PET film having a thickness of 38 μm with release treatment on surfaces was coated with the ethyl acetate solution of a pressure-sensitive adhesive (8) by a bar coater so as to have a thickness of 5 μm after being dried and dry the pressure-sensitive adhesive layer by volatilizing the solvent.

The pressure-sensitive adhesive (7) layer formed on the PET film with corona treatment on one side and the pressure-sensitive adhesive (8) layer formed on the PET film with release treatment were stuck together and, thereafter, cured at a temperature of 40° C. for 3 days to obtain a pressure-sensitive adhesive tape 5.

<Sticking and Peeling of Pressure-Sensitive Adhesive Tape>

The obtained pressure-sensitive adhesive tape 5 was stuck to a quartz glass plate.

This quartz glass plate to which the pressure-sensitive adhesive tape 5 was stuck was heated to 130° C. so as to polymerize and cure the pressure-sensitive adhesive (7) layer and the pressure-sensitive adhesive (8) layer. Subsequently, the quartz glass plate was heated to 180° C. to thereafter observe many parts, in which the pressure-sensitive adhesive was peeled off the glass, on an adhesive interface via the glass. The pressure-sensitive adhesive tape was capable of being easily peeled off the glass plate.

### EXAMPLE 6

### <Preparation of Adhesive Substance>

100 parts by weight of 2,2′-azobis-(N-butyl-2-methyl propionamide) was mixed with 100 parts by weight of resin solids content of the ethyl acetate solution of a pressure-sensitive adhesive (7) manufacture in Example 5 to prepare the ethyl acetate solution of a pressure-sensitive adhesive (9) containing an azo compound.

<Manufacture of Pressure-Sensitive Adhesive Tape>

The surface with corona treatment of a transparent PET film having a thickness of 38 μm with corona treatment on one side was coated with the ethyl acetate solution of a pressure-sensitive adhesive (7) by a doctor knife so as to have a dry film thickness of approximately 10 μm and dry the coating solution by volatilizing the solvent. The pressure-sensitive adhesive layer after being dried exhibited tackiness in a dry state.

Meanwhile, a PET film having a thickness of 38 μm with release treatment on surfaces was coated with the ethyl acetate solution of a pressure-sensitive adhesive (9) by a bar coater so as to have a thickness of 5 μm after being dried and dry the pressure-sensitive adhesive layer by volatilizing the solvent.

The pressure-sensitive adhesive (7) layer formed on the PET film with corona treatment on one side and the pressure-sensitive adhesive (9) layer formed on the PET film with release treatment were stuck together and, thereafter, cured at a temperature of 40° C. for 3 days to obtain a pressure-sensitive adhesive tape 6.

<Sticking and Peeling of Pressure-Sensitive Adhesive Tape>

The obtained pressure-sensitive adhesive tape 6 was stuck to a quartz glass plate.

This quartz glass plate to which the pressure-sensitive adhesive tape 6 was stuck was heated to 130° C. so as to polymerize and cure the pressure-sensitive adhesive (7) layer and the pressure-sensitive adhesive (9) layer. Subsequently, the quartz glass plate was heated to 180° C. to thereafter observe many parts, in which the pressure-sensitive adhesive was peeled off the glass, on an adhesive interface via the glass. The pressure-sensitive adhesive tape was capable of being easily peeled off the glass plate.

### EXAMPLE 7

<Sticking and Peeling of Pressure-Sensitive Adhesive Tape>

The pressure-sensitive adhesive tape 5 obtained in Example 5 was stuck to a quartz glass plate.

This quartz glass plate to which the pressure-sensitive adhesive tape 5 was stuck was heated to 130° C. so as to polymerize and cure the pressure-sensitive adhesive (7) layer and the pressure-sensitive adhesive (8) layer. After being returned to room temperature, the pressure-sensitive a dhesive (7) layer and the pressure-sensitive adhesive (8) layer were irradiated with ultraviolet rays from the side of this quartz glass plate to thereafter observe many parts, in which the pressure-sensitive adhesive was peeled off the glass, on an adhesive interface via the glass. The pressure-sensitive adhesive tape was capable of being easily peeled off the glass plate.

### EXAMPLE 8

<Sticking and Peeling of Pressure-Sensitive Adhesive Tape>

The pressure-sensitive adhesive tape 6 obtained in Example 6 was stuck to a quartz glass plate.

This quartz glass plate to which the pressure-sensitive adhesive tape 6 was stuck was heated to 130° C. so as to polymerize and cure the pressure-sensitive adhesive (7) layer and the pressure-sensitive adhesive (9) layer. After being returned to room temperature, the pressure-sensitive adhesive (7) layer and the pressure-sensitive adhesive (9) layer were irradiated with ultraviolet rays from the side of this quartz glass plate to thereafter observe many parts, in which the pressure-sensitive adhesive was peeled off the glass, on an adhesive interface via the glass. The pressure-sensitive adhesive tape was capable of being easily peeled off the glass plate.

### EXAMPLE 9

<Preparation of Adhesive Substance>

The following compounds were dissolved in ethyl acetate so as to be irradiated with ultraviolet rays for polymerization and obtain an acrylic copolymer having a weight-average molecular weight of 700,000.

3.5 parts by weight of 2-isocyanatoethyl acrylate was added to 100 parts by weight of resin solids content of the ethyl acetate solution containing the obtained acrylic copolymer so as to be reacted, and further 20 parts by weight of pentaerythritol triacrylate, 0.5 part by weight of benzophenone and 1.5 parts by weight of polyisocyanate were mixed with 100 parts by weight of resin solids content of the reacted ethyl acetate solution to prepare the ethyl acetate solution of a pressure-sensitive adhesive (10).

| | | |
|---|---|---|
| butyl acrylate | 79 | parts by weight |
| ethyl acrylate | 15 | parts by weight |
| acrylic acid | 1 | part by weight |
| 2-hydroxyethyl acrylate | 5 | parts by weight |
| photopolymerization initiator (IRGACURE 651, | 0.2 | part by weight |
| 50%-ethyl acetate solution) | | |
| lauryl mercaptan | 0.01 | part by weight |

100 parts by weight of 2,2′-azobis-(N-butyl-2-methyl propionamide) was mixed with 100 parts by weight of resin solids content of the ethyl acetate solution of a pressure-sensitive adhesive (10) to prepare the ethyl acetate solution of a pressure-sensitive adhesive (11) containing an azo compound.

<Manufacture of Pressure-Sensitive Adhesive Tape>

The surface with corona treatment of a transparent PET film having a thickness of 38 μm with corona treatment on one side was coated with the ethyl acetate solution of a pressure-sensitive adhesive (10) by a doctor knife so as to have a dry film thickness of approximately 10 μm and dry the coating solution by volatilizing the solvent. The pressure-sensitive adhesive layer after being dried exhibited tackiness in a dry state.

Meanwhile, a PET film having a thickness of 38 μm with release treatment on surfaces was coated with the ethyl acetate solution of a pressure-sensitive adhesive (11) by a bar coater so as to have a thickness of 5 μm after being dried and dry the pressure-sensitive adhesive layer by volatilizing the solvent.

The pressure-sensitive adhesive (10) layer formed on the PET film with corona treatment on one side and the pressure-sensitive adhesive (11) layer formed on the PET film with release treatment were stuck together and, thereafter, cured at a temperature of 40° C. for 3 days to obtain a pressure-sensitive adhesive tape 7.

<Sticking and Peeling of Pressure-Sensitive Adhesive Tape>

The obtained pressure-sensitive adhesive tape 7 was stuck to a quartz glass plate.

The obtained pressure-sensitive adhesive tape 7 was irradiated with ultraviolet rays from the side of this quartz glass plate to thereafter observe many parts, in which the pressure-sensitive adhesive was peeled off the glass, on an adhesive interface via the glass. The pressure-sensitive adhesive tape was capable of being easily peeled-off the glass plate.

### EXAMPLE 10

<Preparation of Adhesive Substance>

100 parts by weight of 2,2′-azobis-(N-butyl-2-methyl propionamide) was mixed with 100 parts by weight of resin solids content of the ethyl acetate solution of a pressure-sensitive adhesive (10) manufactured in Example 9 to prepare the ethyl acetate solution of a pressure-sensitive adhesive (12) containing an azo compound.

<Manufacture of Pressure-Sensitive Adhesive Tape>

The surface with corona treatment of a transparent PET film having a thickness of 38 μm with corona treatment on one side was coated with the ethyl acetate solution of a pressure-sensitive adhesive (10) by a doctor knife so as to have a dry film thickness of approximately 10 μm and dry the coating solution by volatilizing the solvent. The pressure-sensitive adhesive layer after being dried exhibited tackiness in a dry state.

Meanwhile, a PET film having a thickness of 38 μm with release treatment on surfaces was coated with the ethyl acetate solution of a pressure-sensitive adhesive (12) by a bar coater so as to have a thickness of 5 μm after being dried and dry the pressure-sensitive adhesive layer by volatilizing the solvent.

The pressure-sensitive adhesive (10) layer formed on the PET film with corona treatment on one side and the pressure-sensitive adhesive (12) layer formed on the PET film with release treatment were stuck together and, thereafter, cured at a temperature of 40° C. for 3 days to obtain a pressure-sensitive adhesive tape 8.

<Sticking and Peeling of Pressure-Sensitive Adhesive Tape>

The obtained pressure-sensitive adhesive tape 8 was stuck to a quartz glass plate.

The obtained pressure-sensitive adhesive tape 8 was irradiated with ultraviolet rays from the side of this quartz glass plate to thereafter observe many parts, in which the pressure-sensitive adhesive was peeled off the glass, on an adhesive interface via the glass. The pressure-sensitive adhesive tape was capable of being easily peeled off the glass plate.

### INDUSTRIAL APPLICABILITY

The present invention can provide an adhesive substance capable of being easily peeled off without damaging an adherend by giving stimulation thereto, a pressure-sensitive adhesive tape employing this adhesive substance, and a method for peeling off the adhesive substance.

1-10. (canceled)

11. A method for peeling off the adhesive substance,
containing: a gas-generating agent for gas by stimulation; and a component crosslinkable by stimulation,
wherein the stimulation for generating gas from the gas-generating agent differs from the stimulation for crosslinking the crosslinkable component,
which comprises: starting to give stimulation for crosslinking the crosslinkable component; and then, starting to giving stimulation for generating gas from the gas-generating agent to generate gas from the gas-generating agent, generated gas being discharged to the outside of the adhesive substance to peel at least part of the adhesive surface off the adherend so as to decrease adhesive strength.

12. A method for peeling off the adhesive substance,
containing: a gas-generating agent for generating gas by stimulation via light; and a component crosslinkable by stimulation via light, and
which has a no-overlapped wavelength range between a wavelength range of light for generating gas from the gas-generating agent and a wavelength range of light for crosslinking the crosslinkable component,
which comprises: starting to irradiate the adhesive substance with light not having the wavelength of generating gas from the gas-generating agent but having the wavelength of crosslinking a crosslinkable component; and then, starting to irradiate the adhesive substance with light having the wavelength of generating gas from the gas-generating agent to generate gas from the gas-generating agent, generated gas being discharged to the outside of the adhesive substance to peel at least part of the adhesive surface off the adherend so as to decrease adhesive strength.

13. A method for peeling off the adhesive substance,
containing: a gas-generating agent for generating gas by stimulation via heat; and a component crosslinkable by stimulation via heat,
10-hour half-life temperature of the gas-generating agent for generating gas by stimulation via heat being higher than 10-hour half-life temperature of a thermal polymerization inhibitor in the component crosslinkable by stimulation via heat,
which comprises: heating at a temperature of substantially not generating gas from the gas-generating agent but crosslinking the crosslinkable component; then, heating at a higher temperature than the above temperature to generate gas from the gas-generating agent,
generated gas being discharged to the outside of the adhesive substance to peel at least part of the adhesive surface off the adherend so as to decrease adhesive strength.

14-19. (canceled)

20. A method for peeling off the adhesive substance,
containing: a gas-generating agent for generating gas by stimulation; and a component crosslinkable by stimulation,
gas generated from the gas-generating agent being discharged to the outside of the adhesive substance so as not to foam the adhesive substance, and
gas generated from the gas-generating agent peeling at least part of an adhesive surface of the adhesive substrate off an adherend so as to decrease adhesive strength.
